(19) United States
(12) Patent Application Publication
(10) Pub. No.: US 2006/0085864 A1
(43) Pub. Date: Apr. 20, 2006

(54) Electronic security machine start method for notebook computers

(76) Inventors: Paul Chang, Taipei (TW); Yu-Chi Lin, Taipei (TW)

Correspondence Address: HARNESS, DICKEY & PIERCE, P.L.C., P.O. BOX 8910, RESTON, VA, 20195, US

(21) Appl. No.: 10/965,880

(22) Filed: Oct. 18, 2004

(51) Int. Cl. G06F 11/00

(52) U.S. Cl. 726/34

(57) ABSTRACT

An electronic security machine start method adopted for use on notebook computers include searching a corresponding security information in an entered information memory unit according to an entered information of a user; transmitting a control signal to a lock module to release the locked condition between the display screen and the host; and transmitting a machine start signal to a data processing equipment.

### FIELD OF THE INVENTION

The present invention relates to an electronic security machine start method and particularly to an electronic security machine start method adopted for use on notebook computers, with restriction of the opening and using of data processing equipment.

### BACKGROUND OF THE INVENTION

Research and development of semiconductors and electronic industries in Taiwan have made great progress in recent years. The fabrication and research and development capability of various types of electronic products have won wide recognition worldwide. They have become very significant in the computer market. Among those products, handheld data processing equipment such as mobile phones, personal digital assistants (PDAs) and notebook computers are most important. While their function and expandability may not be as powerful as conventional desktop computers, their document processing power and other basic functions are quite sufficient. Their small size and excellent portability offer a great benefit. Thus they are well accepted in the market and become the mainstream products in the industry.

This is especially true for the notebook computer. The notebook computer generally consists of a host and a display screen that may be opened and closed.

On a notebook computer, the conventional machine start operation is to lift the display screen from the host, and press or push a power switch on the host. After a self-test machine start procedure it is ready to operate. Data stored in the data processing equipment of this type usually include system register data and related passwords, and are stored in storage devices such as hard disks.

In terms of data security, the operation mode set forth above still has drawbacks. The main concern is that the register data and related passwords entered by users may be easily accessed from the hard disks. Intruders can access and decipher the register data and passwords and use the data processing equipment, and usurp the system authority to access other data in the hard disks. It is very difficult to safeguard against such type of intrusion.

### SUMMARY OF THE INVENTION

Therefore the primary object of the present invention is to provide an electronic security machine start method to prevent intruders from pilfering data in the hard disks and using the data processing equipment.

The electronic security machine starting method for notebook computers according to the invention employs an electronic security device that has a lock module located in the host or display screen to keep the host and the display screen closed and locked in normal conditions. The method includes the procedure of: first, the system equipment enters a standby mode; next, comparing user's entering information with the security information in an entered information memory unit corresponding to the user's entering information; transmitting a control signal to a lock module when the two information match, to release the locked condition of host and display screen; transmitting a machine start signal to the data processing equipment to proceed the usual machine start procedure.

The electronic security machine start method for notebook computers according to the invention uses independent devices. Hence intruders cannot access user's data and passwords from the hard disk through the general approach. This provides a more secured operation environment. Namely, users have to pass the verification of the electronic security device of the invention to use the data processing equipment. Otherwise, the data processing equipment cannot be opened or used. In addition, if the data processing equipment is opened and used, and the user has to leave, the data processing equipment may be closed and locked through the electronic security device of the invention to prevent other people from using or seeing the information on the screen, therefore provides a desired data protection function.

Moreover, the invention controls-locking of the display screen and the host through an electronic approach. This is different from the push approach used in the conventional technique, to unlock the display screen and the host. This is more convenient to use.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the electronic security device used in the electronic security machine start method adopted for use on notebook computers according to the invention.

FIG. 2 is a schematic view of the data processing equipment opened according to the method of the invention.

FIG. 3 is a system architecture according to the method of the invention.

FIG. 4 is a process flow chart according to the method of the invention.

FIG. 5 is another process flow chart according to the method of the invention.

### DESCRIPTION OF THE PREFERRED EMBODIMENTS

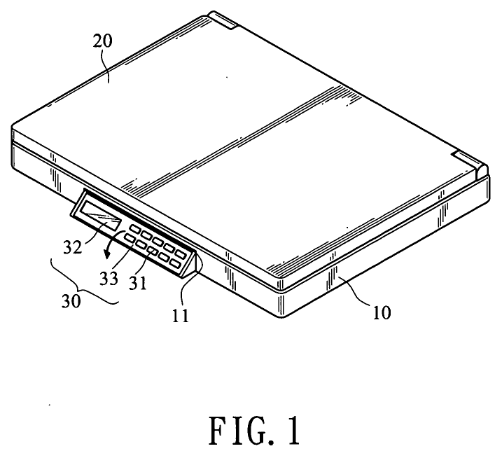

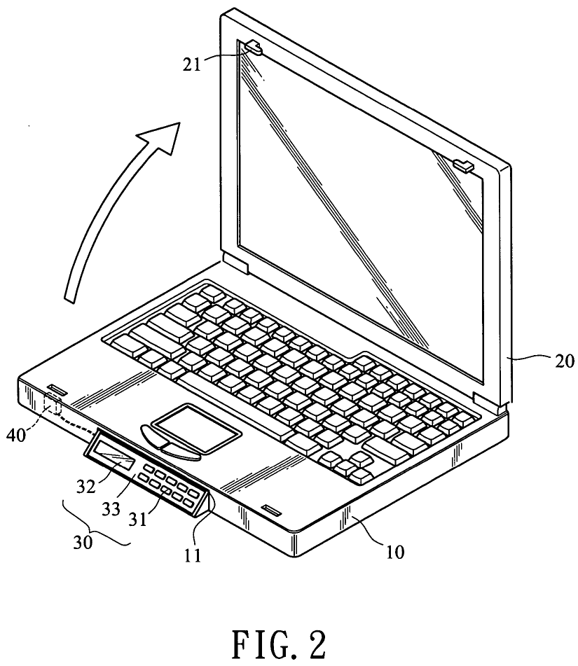

Please refer to FIGS. 1 and 2 for the electronic security device used in the method of the present invention. It is used on data processing equipment that has a lifting lid such as a notebook computer or the like. The notebook computer usually has a host 10 and a movable display screen 20 that may be closed or lifted and opened relative to each other. The host 10 has a housing trough 11 on one side. The display screen 20 has a hook 21 corresponding to one side of the host 10.

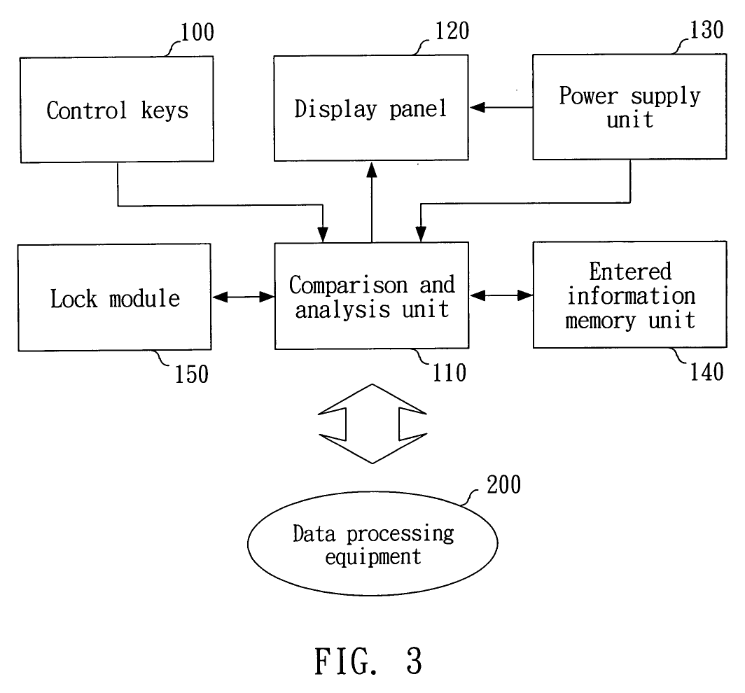

The electronic security device according to the invention includes a case 33, a display panel 32, control buttons 31 and a lock module 40. The case 33 is pivotally coupled in the housing trough 11 and may be turned and nestled in the housing trough 11 at a storing position, or turned and extended from the host 10 at a use position. The case 33 contains electronic elements needed in the operation that will be discussed later, accompanying FIG. 3. The display panel 32 is located on one side of the case and is connected electrically to the electronic elements to receive signals from the electronic elements and display condition information. The control buttons are located on the case 33, abutting the display panel 32, and are on the same side of the display panel 32. Further, they are connected electrically to the electronic elements for user operation. The lock module 40 also is connected to the electronic elements, and may be latched on the hook 21 in normal condition to keep the display screen 20 and the host 10 in a closed and locked condition so that they cannot be opened. The lock module 40 can receive a control signal sent by the electronic elements to release the latched and locked condition to allow the display screen 20 to be lifted and opened from the host 10. The lock module 40 has many selections. This generally is a solenoid switch.

Refer to FIG. 3 for the electronic elements, namely, the system architecture of the invention. The electronic security device of the invention is used in data processing equipment and mainly includes:

(1) a control key 100 to allow users to enter information (such as a user name) and security information (such as a password);

(2) an entered information memory unit 140 to store user information and security information entered by the users;

(3) a comparison and analysis unit 110 to receive the entered information of the users, and search and compare with security information entered by the operator, and compare with the stored data in the entered information memory unit 140 and determine whether they match. If they match, send a machine start signal to a data processing equipment 200 to proceed machine start procedures;

(4) a display panel 120 to display messages sent by the comparison and analysis unit 110;

(5) a power supply unit 130 to provide electric power required by the comparison and analysis unit 110 and the display panel 120. The electric power also may be provided by data processing equipment; and

(6) a lock module 150 to receive the control signal sent by the comparison and analysis unit 110 to release the locking condition with the hook 21 (referring to FIG. 1) and to allow the display screen 20 to be lifted and opened from the host 10 for use.

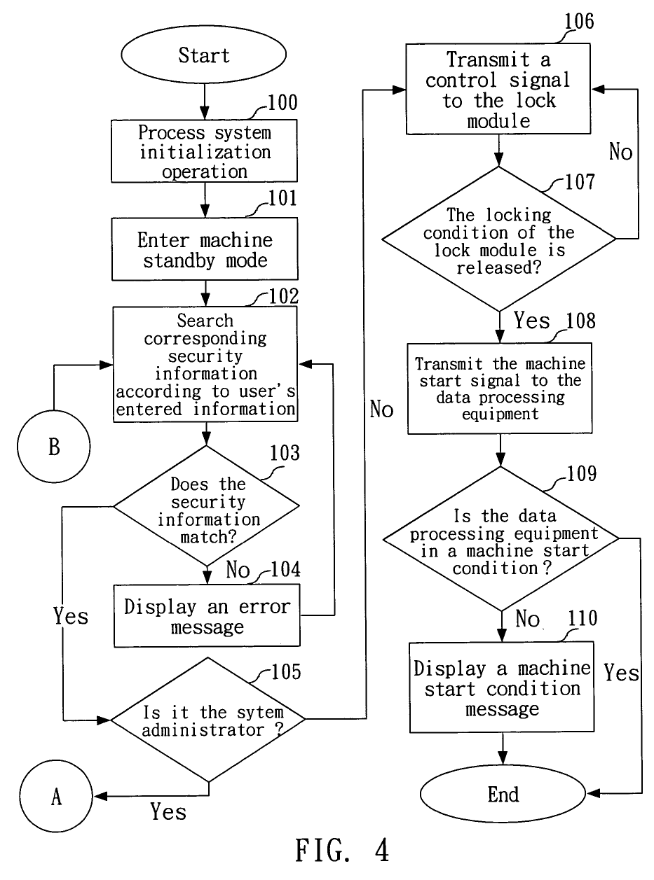

Refer to FIG. 4 for the process flow of the invention.

First, process system initialization operation (step 100); enter the machine standby mode (step 101) and wait for user operation; once the user enters user information (such as a user name), the system places the user information in the entered information memory unit and searches and accesses the security information corresponding to the entered information (step 102); the user enters the security information, and the system compares and verifies whether the security information matches (step 103); display error messages if the information does not match, (step 104), and return to step 102; if the security information matches, the system determines whether the entered information is a System Administrator (step 105); if positive, go to step A which will be discussed later; if negative, the system sends a control signal to the lock module (step 106) to release the locked and closed condition of the display screen and the host; meanwhile, the system confirms whether the locked condition of the lock module is released (step 107); if negative, return to step 106 to try unlocking again; if positive, the system sends a machine start signal to the data processing equipment (step 108); the data processing equipment proceeds machine start operations such as a self-test and the like, and the system confirms if the data processing equipment is in a machine start condition (step 109); if the machine start operations fail, display a message of the machine start condition to alert the user; otherwise end the entire process.

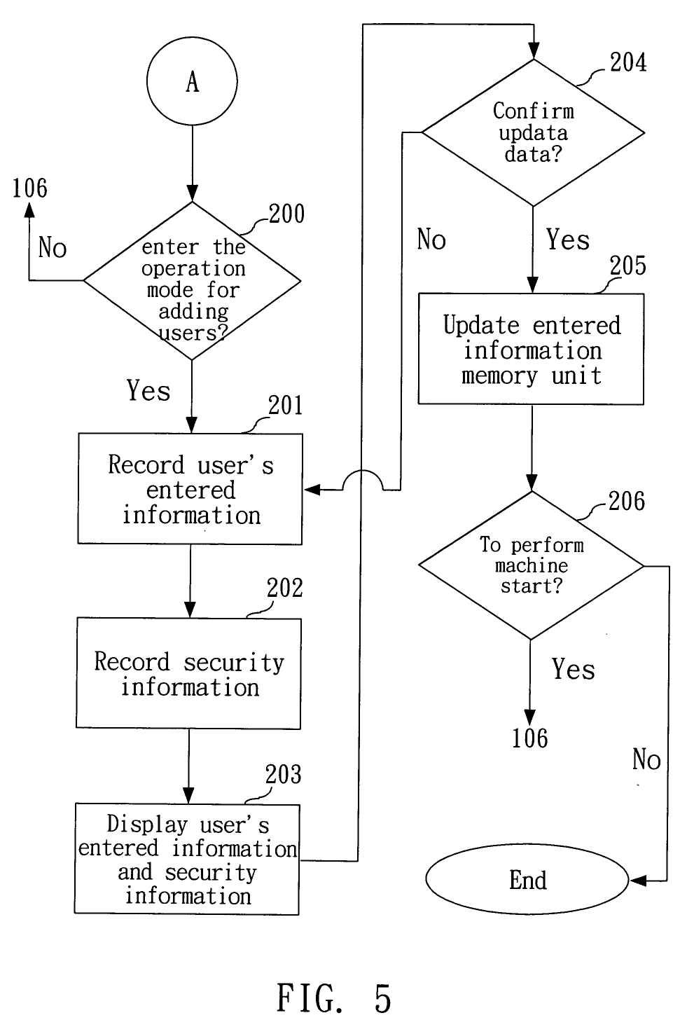

Refer to FIG. 5 for the process of step A. First, the information entered by the user is confirmed to be the System Administrator, and the system inquires the operator whether to enter the operation mode for adding users (step 200); if negative, return to step 106; if positive, record user entered information input by the operator (step 201); and record security information (step 202); the system displays user entered information and security information (step 203) for operator confirmation; next, the system confirms whether to update data (step 204); if negative, return to step 201; if positive, update the data in the memory unit (step 205); finally, the system inquires whether to start the machine (step 206); if positive, go to step 106; if negative, end the process.

While the preferred embodiments of the invention have been set forth for the purpose of disclosure, modifications of the disclosed embodiments of the invention as well as other embodiments thereof may occur to those skilled in the art Accordingly, the appended claims are intended to cover all embodiments, which do not depart from the spirit and scope of the invention.

What is claimed is:

1. An electronic security device for a notebook computer which has a host and a display screen that are movable relative to each other for opening and closing, the host having a housing trough on one side, the display screen having a hook corresponding to the one side of the host, the device comprising:
a case containing electronic elements required for operation and being pivotally coupled in the housing trough to be turned and extended outside the housing trough at a use position and to be nestled in the housing trough at a storing position;
a display panel located on one side of the case being electrically connected to the electronic elements to display a condition information;
a plurality of control buttons located on the case on the same side of the display panel being electrically connected to the electronic elements for user operation; and
a lock module having a locking position to latch the hook to close the display screen on the host in normal conditions and a unlocking position to release the latch condition of the hook according to a control signal sent by the electronic elements.

2. The electronic security device of claim 1, wherein the lock module is a solenoid valve.

3. An electronic security machine start method for a notebook computer which has a host and a display screen that are movable relative to each other for opening and closing, the method comprising the steps of:
entering a machine standby mode;
searching a security information in an entered information memory unit according to an entered information of a user and comparing the entered information with the security information;
transmitting a control signal to a lock module to release a locking condition between the display screen and the host; and
transmitting a machine start signal to the notebook computer.

4. The method of claim 3, wherein the searching a security information in an entered information memory unit according to an entered information of a user and comparing the entered information with the security information further includes displaying an error message to alert the user.

5. The method of claim 3, wherein the transmitting a control signal to a lock module further includes confirming the locking condition of the lock module.

6. The method of claim 3, wherein the transmitting a machine start signal to the notebook computer further includes confirming machine start conditions of the notebook computer.

7. The method of claim 6, wherein the confirming machine start conditions of notebook computer further includes displaying a machine start condition message.

8. The method of claim 3, wherein the searching a security information in an entered information memory unit according to an entered information of a user and comparing the entered information with the security information further includes:
entering an operation mode for adding users;
recording entered information of a user;
recording a security information; and
updating the entered information memory unit.

9. The method of claim 3, wherein the lock module is a solenoid valve.
